(19) United States
(12) Patent Application Publication
(10) Pub. No.: US 2025/0309291 A1
(43) Pub. Date: Oct. 2, 2025

(54) METHOD FOR MANUFACTURING MEMBRANE ELECTRODE ASSEMBLY

(71) Applicant: HONDA MOTOR CO., LTD., TOKYO (JP)

(72) Inventors: Kento KUSATSUGU, WAKO-SHI (JP); Wataru KASHI, WAKO-SHI (JP); Yohei KATAOKA, WAKO-SHI (JP); Shinsuke CHOKYU, WAKO-SHI (JP)

(21) Appl. No.: 19/065,023

(22) Filed: Feb. 27, 2025

(30) Foreign Application Priority Data
Mar. 27, 2024 (JP) 2024-050959

(51) Int. Cl. H01M 8/04089; C25B 1/04; H01M 4/88; H01M 8/1004

(52) U.S. Cl. CPC H01M 8/04104; C25B 1/04; H01M 4/8892; H01M 8/1004

(57) ABSTRACT

In a first stacked body providing step, a first stacked body, in which a first ionomer material having an ion exchange capacity of less than a predetermined value and a first electrode are stacked, is provided. In a second stacked body providing step, a second stacked body, in which a second ionomer material having an ion exchange capacity of equal to or greater than the predetermined value and a second electrode are stacked, is provided. In a substrate providing step, an electrolyte substrate is provided. In a swelling step, the first stacked body, the second stacked body, and the electrolyte substrate are caused to swell. In a joining step, the electrolyte substrate and the first ionomer material of the first stacked body are joined together, and the electrolyte substrate and the second ionomer material of the second stacked body are joined together.

### CROSS-REFERENCE TO RELATED APPLICATIONS

This application is based upon and claims the benefit of priority from Japanese Patent Application No. 2024-050959 filed on Mar. 27, 2024, the contents of which are incorporated herein by reference.

### BACKGROUND OF THE INVENTION

### Field of the Invention

The present disclosure relates to a method for manufacturing a membrane electrode assembly.

### Description of the Related Art

In recent years, technological development has been conducted on electrolysis stacks that contribute to energy efficiency in order to ensure that more people have access to affordable, reliable, sustainable and modern energy. Conventionally, an electrolysis apparatus including an electrolysis stack formed of a plurality of electrolysis cells stacked on each other is known. The electrolysis cells each include a membrane electrode assembly. The membrane electrode assembly has a structure in which an electrolyte membrane is sandwiched between a pair of electrodes. Examples of the electrolysis cell include a water electrolysis cell that electrolyzes water, and a hydrogen electrolysis cell that electrolyzes hydrogen (hydrogen gas). An electrolysis stack including a stacked body in which a plurality of water electrolysis cells are stacked is sometimes referred to as a water electrolysis apparatus. An electrolysis stack including a stacked body in which a plurality of hydrogen electrolysis cells are stacked is sometimes referred to as an electrochemical hydrogen compressor (EHC). For example, JP 2019-157212 A discloses a water electrolysis apparatus including water electrolysis cells.

### SUMMARY OF THE INVENTION

For example, in a water electrolysis apparatus, the membrane electrode assembly absorbs water and swells during electrolysis, and therefore, the membrane electrode assembly undergoes a dimensional change. Therefore, the state of the membrane electrode assembly differs between the time of completion of assembly of the water electrolysis apparatus and the time of use of the water electrolysis apparatus (the time of electrolysis). In order to make the state of the membrane electrode assembly at the time of completion of assembly of the water electrolysis apparatus the same as the state thereof at the time of electrolysis, it is conceivable that the membrane electrode assembly is immersed to swell in water before being assembled as an electrolysis stack.

However, with the above-described method, there is a concern that wrinkles may occur in the membrane electrode assembly (particularly, the electrolyte membrane) due to a difference in swelling rate when the electrodes and the electrolyte membrane swell with water.

The present disclosure has the object of solving the above-described problem.

An aspect of the present disclosure is a method for manufacturing a membrane electrode assembly used in a differential pressure electrolysis apparatus including the membrane electrode assembly that includes an electrolyte membrane, and a first electrode and a second electrode that are stacked on both sides of the electrolyte membrane, respectively, the differential pressure electrolysis apparatus being configured to supply a fluid for electrolysis to the first electrode, apply a voltage between the first electrode and the second electrode, and obtain, at the second electrode, a second gas at a higher pressure than a first gas obtained at the first electrode, the method comprising: a first stacked body providing step of providing a first stacked body formed by stacking the first electrode and a first ionomer material whose ion exchange capacity per unit area under a predetermined temperature and predetermined humidity atmosphere is less than a predetermined value; a second stacked body providing step of providing a second stacked body formed by stacking the second electrode and a second ionomer material whose ion exchange capacity per unit area under the predetermined temperature and predetermined humidity atmosphere is equal to or greater than the predetermined value; a substrate providing step of providing an electrolyte substrate including a first surface and a second surface on an opposite side from the first surface; a swelling step of swelling the first stacked body, the second stacked body, and the electrolyte substrate; and a joining step of, after the swelling step, joining together the first surface of the electrolyte substrate and the first ionomer material of the first stacked body, and joining together the second surface of the electrolyte substrate and the second ionomer material of the second stacked body.

According to the present disclosure, the first stacked body, the second stacked body, and the electrolyte substrate are caused to swell, and then the first stacked body and the electrolyte substrate are joined together, and the second stacked body and the electrolyte substrate are joined together. Therefore, the occurrence of wrinkles in the electrolyte membrane can be suppressed. Further, in the membrane electrode assembly obtained by this manufacturing method, the ion exchange capacity of the portion (the second adjacent portion) of the electrolyte membrane that is adjacent to the second electrode is larger than the ion exchange capacity of the portion (the first adjacent portion) of the electrolyte membrane that is adjacent to the first electrode. Therefore, in a case where the differential pressure electrolysis apparatus is a water electrolysis apparatus, by suppressing drying of the second adjacent portion of the electrolyte membrane, which is a portion on the high pressure side, it is possible to suppress a decrease in electrolysis efficiency, and the progression of deterioration of the electrolyte membrane due to an increase in electrical resistance.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a differential pressure electrolysis apparatus;

FIG. 2 is a cross-sectional view of an electrolysis cell; and

FIG. 3 is a schematic view illustrating a method for manufacturing a membrane electrode assembly according to an embodiment of the present disclosure.

### DETAILED DESCRIPTION OF THE INVENTION

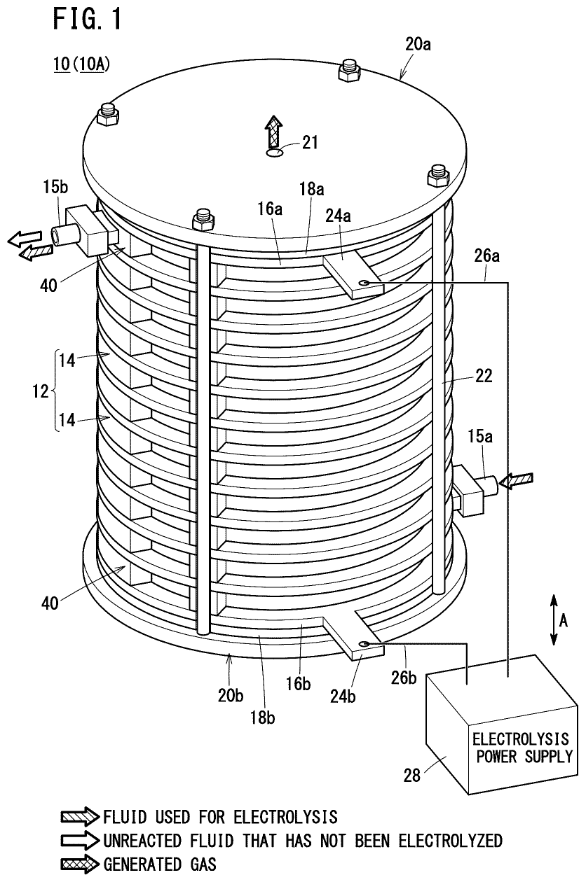

As shown in FIG. 1, a differential pressure electrolysis apparatus 10 is configured as an electrolysis stack 10A including a cell stacked body 12. The electrolysis stack 10A has a substantially cylindrical shape as a whole, but can be formed in various shapes such as a cubic shape. The cell stacked body 12 includes a plurality of electrolysis cells 14 stacked in a vertical direction or a horizontal direction. The electrolysis cells 14 are water electrolysis cells. The electrolysis cells 14 may be hydrogen electrolysis cells. In the following description, a “stacking direction” means a stacking direction (A direction) of the plurality of electrolysis cells 14.

A fluid introduction opening 15a is provided in the electrolysis cell 14 located at one end (lower end) in the stacking direction among the plurality of electrolysis cells 14. A fluid lead-out opening 15b is provided in the electrolysis cell 14 located at the other end (upper end) in the stacking direction among the plurality of electrolysis cells 14.

The differential pressure electrolysis apparatus 10 further includes a pair of terminal plates 16a and 16b, a pair of insulating plates 18a and 18b, and a pair of end plates 20a and 20b. The terminal plate 16a, the insulating plate 18a, and the end plate 20a are arranged in this order toward one side in the stacking direction (upward in FIG. 1). The terminal plate 16b, the insulating plate 18b, and the end plate 20b are arranged in this order toward the other side in the stacking direction (downward in FIG. 1).

The terminal plates 16a and 16b are provided with terminals 24a and 24b, respectively. The terminals 24a and 24b are electrically connected to an electrolysis power supply 28 via wires 26a and 26b, respectively.

The electrolysis stack 10A is held in a state where the end plates 20a and 20b are integrally fastened by a pressing mechanism such as a plurality of tie rods 22 extending in the stacking direction. A pipe (not shown) communicating with a high-pressure fluid discharge hole 21 described later is connected to the end plate 20a. The pipe is provided with a back pressure mechanism capable of regulating the discharge of gas via the high-pressure fluid discharge hole 21. The electrolysis stack 10A may be provided with a box-shaped casing (not shown) including the end plates 20a and 20b.

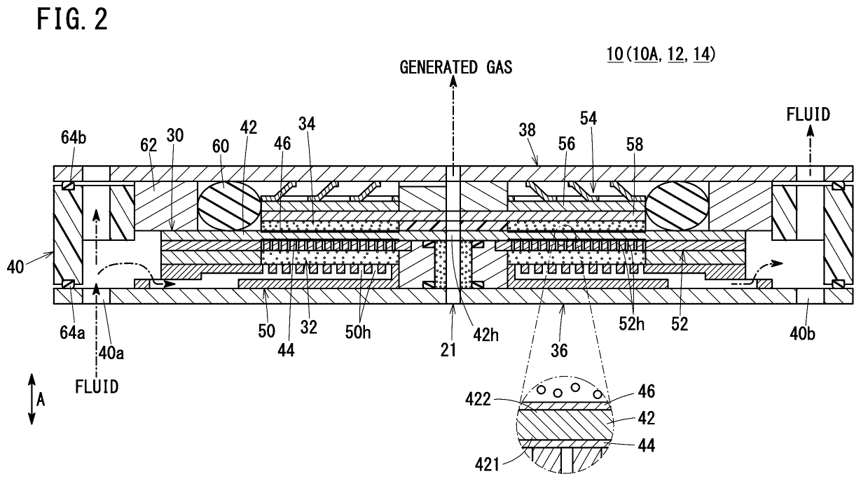

As shown in FIG. 2, the electrolysis cell 14 includes a membrane electrode assembly 30, a first current collector 32, a second current collector 34, a first separator 36, a second separator 38, and a resin frame member 40.

The membrane electrode assembly 30 has a substantially circular ring shape. The membrane electrode assembly 30 includes an electrolyte membrane 42, a first electrode 44, and a second electrode 46. The electrolyte membrane 42 is made of a solid polymer. The electrolyte membrane 42 is made of ionomer. The electrolyte membrane 42 is a membrane capable of exchanging ions. The first electrode 44 is disposed on one surface of the electrolyte membrane 42. The first electrode 44 is an electrode catalyst layer. A fluid used for electrolysis is supplied to the first electrode 44. The second electrode 46 is disposed on the other surface of the electrolyte membrane 42. The second electrode 46 is an electrode catalyst layer on the opposite side from the first electrode 44. A voltage is applied between the first electrode 44 and the second electrode 46 by the electrolysis power supply 28 (FIG. 1).

In a case where the electrolysis cell 14 is a water electrolysis cell, the electrolyte membrane 42 may be an anion exchange membrane or a proton exchange membrane.

In a case where the electrolyte membrane 42 is an anion exchange membrane, the fluid used for electrolysis is alkaline water. In a case where the electrolysis cell 14 is a water electrolysis cell, the electrolyte membrane 42 is an anion exchange membrane, the first electrode 44 and the first current collector 32 function as the anode, and the second electrode 46 and the second current collector 34 function as the cathode, oxygen is generated as a first gas at the first electrode 44, and hydrogen is generated as a second gas at the second electrode 46. On the other hand, in a case where the electrolysis cell 14 is a water electrolysis cell, the electrolyte membrane 42 is an anion exchange membrane, the first electrode 44 and the first current collector 32 function as the cathode, and the second electrode 46 and the second current collector 34 function as the anode, hydrogen is generated at the first electrode 44, and oxygen is generated at the second electrode 46.

In a case where the electrolysis cell 14 is a water electrolysis cell and the electrolyte membrane 42 is a proton exchange membrane, the fluid used for electrolysis is water containing impurities in a predetermined amount or less (for example, pure water). In a case where the electrolysis cell 14 is a water electrolysis cell, the electrolyte membrane 42 is a proton exchange membrane, the first electrode 44 and the first current collector 32 function as the anode, and the second electrode 46 and the second current collector 34 function as the cathode, oxygen is generated at the first electrode 44, and hydrogen is generated at the second electrode 46. On the other hand, in a case where the electrolysis cell 14 is a water electrolysis cell, the electrolyte membrane 42 is a proton exchange membrane, the first electrode 44 and the first current collector 32 function as the cathode, and the second electrode 46 and the second current collector 34 function as the anode, hydrogen is generated at the first electrode 44, and oxygen is generated at the second electrode 46.

In a case where the electrolysis cell 14 is a hydrogen electrolysis cell, the electrolyte membrane 42 is a proton exchange membrane. In this case, the fluid used for electrolysis is hydrogen. Further, the first electrode 44 and the first current collector 32 function as the anode, and the second electrode 46 and the second current collector 34 function as the cathode. At the second electrode 46, hydrogen is generated at a higher pressure than the hydrogen supplied to the first electrode 44.

A through hole 42h is formed in the electrolyte membrane 42 at substantially the center in the radial direction. The first electrode 44 is provided on a part of one surface of the electrolyte membrane 42, the part being located between the portion of the electrolyte membrane 42 on the periphery of the through hole 42h and the outer peripheral edge portion of the electrolyte membrane 42. The second electrode 46 is provided on a part of the other surface of the electrolyte membrane 42. The second electrode 46 is provided on a part of the other surface of the electrolyte membrane 42, the part being located between the portion of the electrolyte membrane 42 on the periphery of the through hole 42h and the outer peripheral edge portion of the electrolyte membrane 42. The first electrode 44 and the second electrode 46 are formed in a circular shape, for example. For example, a ruthenium (Ru)-based catalyst is used for the first electrode 44. For example, a platinum catalyst is used for the second electrode 46.

The electrolyte membrane 42 includes a portion adjacent to the first electrode 44 (hereinafter also referred to as a “first adjacent portion 421”), and a portion adjacent to the second electrode 46 (hereinafter also referred to as a “second adjacent portion 422”). The ion exchange capacity (IEC) per unit area of the first adjacent portion 421 under a predetermined temperature and predetermined humidity atmosphere is less than a predetermined value. The ion exchange capacity (IEC) per unit area of the second adjacent portion 422 under the predetermined temperature and predetermined humidity atmosphere is equal to or greater than the predetermined value. Therefore, under the predetermined temperature and predetermined humidity atmosphere, the ion exchange capacity per unit area of the second adjacent portion 422 is larger than the ion exchange capacity per unit area of the first adjacent portion 421. The ion exchange capacity is the reciprocal (meq/g) of the weight of the electrolyte membrane 42 in a dry state required for allowing 1 mol of ions to be exchanged.

The membrane electrode assembly 30 is disposed between the first current collector 32 and the second current collector 34. The first current collector 32 and the second current collector 34 are constituted, for example, by a spherical gas atomizing titanium powder sintered compact (porous conductor), for example. The first current collector 32 and the second current collector 34 are each provided with a smooth surface portion on which an etching process is performed after grinding, and the porosity thereof is set within a range of 10% to 50%, and more preferably, within a range of 20% to 40%.

The first current collector 32 is a current collector (fluid-supply-side current collector) to which a fluid used for electrolysis is supplied. A flow path member 50 is interposed between the first separator 36 and the first current collector 32. A plurality of holes 50h are formed in the flow path member 50. A protective sheet member 52 is interposed between the first current collector 32 and the first electrode 44. A plurality of communication holes 52h are formed in the protective sheet member 52.

The second current collector 34 is a current collector on the opposite side from the first current collector 32. The second current collector 34 is pressed toward the second electrode 46 by a load applying mechanism 54. The load applying mechanism 54 includes, for example, a conductive elastic member such as a plate spring. The load applying mechanism 54 applies a load to the second current collector 34 via a holder 56 made of metal. A circular ring-shaped conductive sheet 58 is disposed between the second current collector 34 and the holder 56.

A seal member 60 is disposed between the electrolyte membrane 42 and the second separator 38 on the radially outer side of an electrolysis region of the membrane electrode assembly 30. A pressure-resistant member 62 is disposed on the radially outer side of the seal member 60. The pressure-resistant member 62 has a substantially ring shape. The outer circumferential portion of the pressure-resistant member 62 is fitted into the inner circumferential portion of the resin frame member 40.

The first separator 36 and the second separator 38 sandwich the membrane electrode assembly 30 and the like in the stacking direction. The first separator 36 and the second separator 38 are substantially disc-shaped and are made, for example, of a carbon member of the like. The first separator 36 and the second separator 38 may be formed by press forming steel plates, stainless steel plates, titanium plates, aluminum plates, steel plates subjected to a plating process, or metal plates subjected to an anti-corrosive surface treatment on the metal surfaces thereof. Alternatively, the first separator 36 and the second separator 38 may also be formed by applying an anti-corrosive surface treatment after having carried out a cutting process.

The resin frame member 40 is disposed between the first separator 36 and the second separator 38 so as to surround the membrane electrode assembly 30 and the like. The resin frame member 40 has a substantially ring shape. Seal members 64a and 64b are provided respectively on both surfaces of the resin frame member 40. The resin frame member 40 includes a fluid inlet 40a and a fluid outlet 40b. The fluid inlet 40a is a flow path for introducing a fluid used for electrolysis. The fluid inlet 40a extends in the stacking direction. The fluid inlets 40a of the plurality of stacked electrolysis cells 14 communicate with each other. The fluid introduction opening 15a (see FIG. 1) is connected to the resin frame member 40 of the electrolysis cell 14 located at one end (lower end) in the stacking direction among the plurality of electrolysis cells 14.

The fluid outlet 40b is a flow path for discharging a mixed fluid containing an unreacted fluid that has not been electrolyzed. The fluid outlet 40b extends in the stacking direction. The fluid outlets 40b of the plurality of stacked electrolysis cells 14 communicate with each other. The fluid lead-out opening 15b (see FIG. 1) is connected to the resin frame member 40 of the electrolysis cell 14 located at the other end (upper end) in the stacking direction among the plurality of electrolysis cells 14.

The electrolysis cell 14 is provided with the high-pressure fluid discharge hole 21 penetrating the radial central portion of the electrolysis cell 14 in the stacking direction. The high-pressure fluid discharge hole 21 is formed to increase the pressure of a gas generated by electrolysis of the fluid used for electrolysis and discharge the gas. The high-pressure fluid discharge holes 21 of the plurality of stacked electrolysis cells 14 communicate with each other. The generated gas is discharged from the high-pressure fluid discharge hole 21 in a state of being pressurized to, for example, 1 MPa to 80 MPa.

Next, a method for manufacturing the membrane electrode assembly 30 according to the present embodiment will be described.

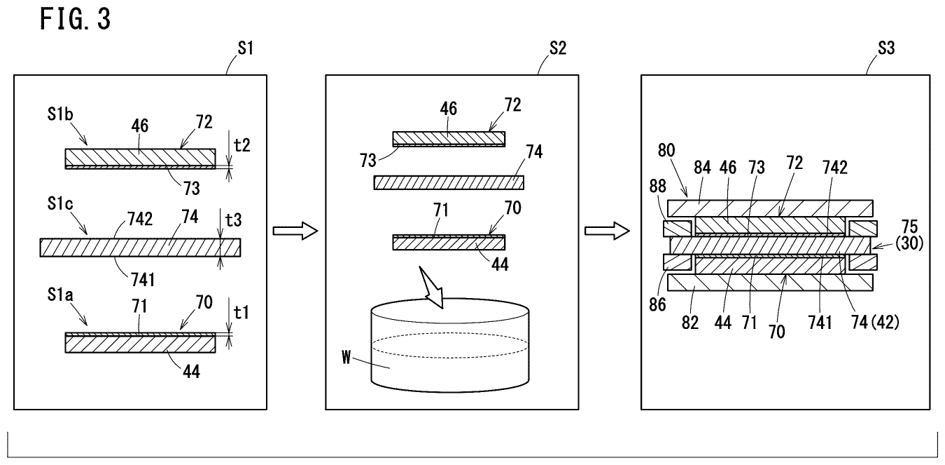

As schematically shown in FIG. 3, the method for manufacturing the membrane electrode assembly 30 includes a member providing step S1, a swelling step S2, and a joining step S3. The member providing step S1 includes a first stacked body providing step S1a, a second stacked body providing step S1b, and a substrate providing step S1c. The first stacked body providing step S1a is a step of providing a first stacked body 70. The second stacked body providing step S1b is a step of providing a second stacked body 72. The substrate providing step S1c is a step of providing an electrolyte substrate 74. Although the first stacked body 70, the second stacked body 72, and the electrolyte substrate 74 are ring-shaped, these shapes are shown in a simplified manner in FIG. 3.

The first stacked body 70 includes the first electrode 44 and a first ionomer material 71 serving as a first layer. The first electrode 44 and the first ionomer material 71 are stacked on each other. For example, the first stacked body 70 is obtained by applying the first ionomer material 71 to the surface of the first electrode 44. Alternatively, the first stacked body 70 may be obtained by transferring the first electrode 44 to a sheet made of the first ionomer material 71.

The first electrode 44 and the first ionomer material 71 have substantially the same diameter. In the stacking direction of the first electrode 44 and the first ionomer material 71, a thickness t1 of the first ionomer material 71 is much smaller than a thickness t3 of the electrolyte substrate 74. The thickness t1 of the first ionomer material 71 is, for example, 5 μm to 50 μm. The thickness t1 of the first ionomer material 71 is, for example, 3% to 50% of the thickness t3 of the electrolyte substrate 74.

The second stacked body 72 includes the second electrode 46 and a second ionomer material 73 serving as a second layer. The second electrode 46 and the second ionomer material 73 are stacked on each other. For example, the second stacked body 72 is obtained by applying the second ionomer material 73 to the surface of the second electrode 46. Alternatively, the second stacked body 72 may be obtained by transferring the second electrode 46 to a sheet made of the second ionomer material 73.

The second electrode 46 and the second ionomer material 73 have substantially the same diameter. In the stacking direction of the second electrode 46 and the second ionomer material 73, a thickness t2 of the second ionomer material 73 is much smaller than the thickness t3 of the electrolyte substrate 74. The thickness t2 of the second ionomer material 73 is, for example, 5 μm to 50 μm. The thickness t2 of the second ionomer material 73 is, for example, 3% to 50% of the thickness t3 of the electrolyte substrate 74.

The electrolyte substrate 74 is made of ionomer. The electrolyte substrate 74 has a first surface 741 and a second surface 742 on the opposite sides from each other. The thickness t3 of the electrolyte substrate 74 is, for example, 100 μm to 150 μm. The electrolyte substrate 74 is, for example, circular. The diameter of the electrolyte substrate 74 is larger than the diameter of the first stacked body 70 and the diameter of the second stacked body 72.

The ion exchange capacity per unit area of the first ionomer material 71 under a predetermined temperature and predetermined humidity atmosphere is less than a predetermined value. Under the predetermined temperature and predetermined humidity atmosphere, the ion exchange capacity per unit area of the first ionomer material 71 is smaller than the ion exchange capacity per unit area of the electrolyte substrate 74. The ion exchange capacity per unit area of the second ionomer material 73 under the predetermined temperature and predetermined humidity atmosphere is equal to or greater than the predetermined value. Under the predetermined temperature and predetermined humidity atmosphere, the ion exchange capacity per unit area of the second ionomer material 73 is larger than the ion exchange capacity per unit area of the electrolyte substrate 74. Therefore, under the predetermined temperature and predetermined humidity atmosphere, the ion exchange capacity per unit area of the second ionomer material 73 is larger than the ion exchange capacity per unit area of the first ionomer material 71.

The swelling step S2 is a step of swelling the first stacked body 70, the second stacked body 72, and the electrolyte substrate 74. Specifically, in the swelling step S2, the first stacked body 70, the second stacked body 72, and the electrolyte substrate 74 are immersed in water W. By the immersion, water permeates into the first stacked body 70, the second stacked body 72, and the electrolyte substrate 74, and the first stacked body 70, the second stacked body 72, and the electrolyte substrate 74 swell. Therefore, the thickness t1 and the diameter of the first ionomer material 71 in the swollen state are larger than the thickness t1 and the diameter of the first ionomer material 71 before swelling. The thickness t2 and the diameter of the second ionomer material 73 in the swollen state are larger than the thickness t2 and the diameter of the second ionomer material 73 before swelling. The thickness t3 and the diameter of the electrolyte substrate 74 in the swollen state are larger than the thickness t3 and the diameter of the electrolyte substrate 74 before swelling.

The swelling rate of the first ionomer material 71 is higher than the swelling rate of the first electrode 44, but the thickness t1 of the first ionomer material 71 is much smaller than the thickness t3 of the electrolyte substrate 74, and therefore the occurrence of wrinkles in the first ionomer material 71 is suppressed. Even if wrinkles occur in the first ionomer material 71, the size of the wrinkles is minute. Similarly, the swelling rate of the second ionomer material 73 is higher than the swelling rate of the second electrode 46, but the thickness t2 of the second ionomer material 73 is much smaller than the thickness t3 of the electrolyte substrate 74, and therefore the occurrence of wrinkles in the second ionomer material 73 is suppressed. Even if wrinkles occur in the second ionomer material 73, the size of the wrinkles is minute.

After the swelling step S2, the joining step S3 is performed. The joining step S3 is a step of joining together the first surface 741 of the electrolyte substrate 74 and the first ionomer material 71 of the first stacked body 70, and joining together the second surface 742 of the electrolyte substrate 74 and the second ionomer material 73 of the second stacked body 72. The joining step S3 can be performed using, for example, a hot press device 80.

The hot press device 80 includes a first die 82, a second die 84, a first holding member 86, and a second holding member 88. The first die 82 is a lower die. The second die 84 is an upper die that is movable in the up-down direction.

The first holding member 86 has a circular ring shape. The second holding member 88 has a circular ring shape. In a preparation process before joining, the outer peripheral edge portion of the electrolyte substrate 74 is held between the first holding member 86 and the second holding member 88. As a result, the first holding member 86 faces the first surface 741 of the electrolyte substrate 74 and abuts against the outer peripheral edge portion of the electrolyte substrate 74. The second holding member 88 faces the second surface 742 of the electrolyte substrate 74 and abuts against the outer peripheral edge portion of the electrolyte substrate 74.

In a state where the electrolyte substrate 74 is stretched by sandwiching the outer peripheral edge portion of the electrolyte substrate 74 between the first holding member 86 and the second holding member 88, the first stacked body 70 is inserted into the inner side of the first holding member 86 and the second stacked body 72 is inserted into the inner side of the second holding member 88. As a result, the electrolyte substrate 74 is disposed between the first stacked body 70 and the second stacked body 72. In this case, the first ionomer material 71 of the first stacked body 70 and the first surface 741 of the electrolyte substrate 74 are in contact with each other in a state where the first stacked body 70 is disposed on the inner side of the first holding member 86. Further, the second ionomer material 73 of the second stacked body 72 and the second surface 742 of the electrolyte substrate 74 are in contact with each other in a state where the second stacked body 72 is disposed on the inner side of the second holding member 88.

In the joining step S3, a stacked structure 75 including the first stacked body 70, the electrolyte substrate 74, and the second stacked body 72 is sandwiched between the first die 82 and the second die 84, and is pressurized and heated. Consequently, the first surface 741 of the electrolyte substrate 74 and the first ionomer material 71 of the first stacked body 70 are joined together, and the second surface 742 of the electrolyte substrate 74 and the second ionomer material 73 of the second stacked body 72 are joined together.

Even if wrinkles have occurred in the first ionomer material 71 due to swelling, the wrinkles in the first ionomer material 71 are integrated into the electrolyte substrate 74 and substantially disappear by the pressure and heat from the hot press device 80 when the electrolyte substrate 74 and the first ionomer material 71 are joined together. Similarly, even if wrinkles have occurred in the second ionomer material 73 due to swelling, the wrinkles in the second ionomer material 73 are integrated into the electrolyte substrate 74 and substantially disappear by the pressure and heat from the hot press device 80 when the electrolyte substrate 74 and the second ionomer material 73 are joined together.

The electrolyte substrate 74, the first ionomer material 71, and the second ionomer material 73 are integrated to form the electrolyte membrane 42. Therefore, the membrane electrode assembly 30 (see also FIG. 2) is obtained by the joining step S3. During the period from the completion of the swelling step S2 to the start of the joining step S3, a small amount of water evaporates from the first stacked body 70, the electrolyte substrate 74, and the second stacked body 72, but the first stacked body 70, the electrolyte substrate 74, and the second stacked body 72 are still swollen. Further, a small amount of water evaporates from the first stacked body 70, the electrolyte substrate 74, and the second stacked body 72 in the joining step S3, but the first stacked body 70, the electrolyte substrate 74, and the second stacked body 72 are still swollen because a sufficient amount of water is retained in the first stacked body 70, the electrolyte substrate 74, and the second stacked body 72. Therefore, even when the joining step S3 is completed, the swollen state of the membrane electrode assembly 30 is maintained.

A plurality of the membrane electrode assemblies 30 are obtained by the above-described manufacturing method. The electrolysis stack 10A (see FIG. 1) is manufactured by using the plurality of membrane electrode assemblies 30. In this case, the electrolysis stack 10A is assembled with the plurality of membrane electrode assemblies 30 brought into a swollen state similar to that at the time of electrolysis. Therefore, it is possible to suppress the occurrence of wrinkles in the membrane electrode assemblies 30 at the time of electrolysis.

The present embodiment has the following effects.

According to the method of manufacturing the membrane electrode assembly 30, the first stacked body 70, the second stacked body 72, and the electrolyte substrate 74 are caused to swell, and then the first stacked body 70 and the electrolyte substrate 74 are joined together, and the second stacked body 72 and the electrolyte substrate 74 are joined together. Therefore, the occurrence of wrinkles in the electrolyte membrane 42 can be suppressed.

Incidentally, in FIG. 2, in a case where the differential pressure electrolysis apparatus 10 is a water electrolysis apparatus, the water in the electrolyte membrane 42 is pushed toward the first electrode 44 by the high-pressure gas generated at the second electrode 46. Therefore, unlike the membrane electrode assembly 30 manufactured by the manufacturing method according to the embodiment, in a case where the ion exchange capacity of the portion (the second adjacent portion 422) of the electrolyte membrane 42 that is adjacent to the second electrode 46 is equal to the ion exchange capacity of the portion (the first adjacent portion 421) of the electrolyte membrane 42 that is adjacent to the first electrode 44, the water in the second adjacent portion 422, which is part of the water supplied to the electrolyte membrane 42 through the first electrode 44, is pushed back to the first electrode 44 side by the pressure of the high-pressure gas. Therefore, the second adjacent portion 422 is more easily dried than the first adjacent portion 421. When the electrolyte membrane 42 dries, the movement of ions in the electrolyte membrane 42 is inhibited, and thus the electrolysis efficiency may decrease. Further, when the electrolyte membrane 42 dries, deterioration of the electrolyte membrane 42 (particularly, deterioration of the second adjacent portion 422) may progress due to an increase in electrical resistance.

In contrast, in the membrane electrode assembly 30 manufactured by the manufacturing method according to the present embodiment, the ion exchange capacity of the second adjacent portion 422 of the electrolyte membrane 42, which is a portion on the high pressure side, is larger than the ion exchange capacity of the first adjacent portion 421 on the low pressure side. Therefore, in a case where the differential pressure electrolysis apparatus 10 is a water electrolysis apparatus, the maximum water content of the second adjacent portion 422 can be made larger than the maximum water content of the first adjacent portion 421. Therefore, even if the water supplied to the electrolyte membrane 42 through the first electrode 44 is pushed back by the pressure of the high-pressure gas generated at the second electrode 46, drying of the second adjacent portion 422 is suppressed, and the movement of ions in the electrolyte membrane 42 is prevented from being inhibited. In other words, the variation in the water content of the electrolyte membrane 42 in the thickness direction of the electrolyte membrane 42 can be suppressed. As a result, by suppressing drying of the second adjacent portion 422 of the electrolyte membrane 42, which is a portion on the high pressure side, it is possible to suppress a decrease in the electrolysis efficiency and the progression of deterioration of the electrolyte membrane 42 (particularly, deterioration of the second adjacent portion 422).

In FIG. 3, the thickness t1 of the first ionomer material 71 may be different from the thickness t2 of the second ionomer material 73. The thickness t1 of the first ionomer material 71 and the thickness t2 of the second ionomer material 73 are made different from each other, whereby in the electrolyte membrane 42 during electrolysis shown in FIG. 2, the amount of water in the first adjacent portion 421 and the amount of water in the second adjacent portion 422 can be adjusted, and drying of the second adjacent portion 422 can be suppressed.

Each of the first stacked body 70, the second stacked body 72, and the electrolyte substrate 74 has a circular shape. The diameter of each of the first stacked body 70 and the second stacked body 72 is smaller than the diameter of the electrolyte substrate 74. In the joining step S3, on the inner side of the first holding member 86 and the second holding member 88 that hold the outer peripheral edge portion of the electrolyte substrate 74, the first stacked body 70 and the electrolyte substrate 74 are joined together, and the second stacked body 72 and the electrolyte substrate 74 are joined together. As a result, since joining is performed on the inner side of the first holding member 86 and the second holding member 88 while the outer peripheral edge portion of the electrolyte substrate 74 is held by the first holding member 86 and the second holding member 88, the joining step S3 can be performed in a satisfactory manner.

The following supplementary notes are further disclosed in relation to the above-described embodiment.

### Supplementary Note 1

The method for manufacturing the membrane electrode assembly (30) of the present disclosure is a method for manufacturing the membrane electrode assembly used in the differential pressure electrolysis apparatus (10) including the membrane electrode assembly that includes the electrolyte membrane (42), and the first electrode (44) and the second electrode (46) that are stacked on both sides of the electrolyte membrane, respectively, the differential pressure electrolysis apparatus being configured to supply a fluid for electrolysis to the first electrode, apply a voltage between the first electrode and the second electrode, and obtain, at the second electrode, a second gas at a higher pressure than a first gas obtained at the first electrode, the method including: the first stacked body providing step (S1a) of providing the first stacked body (70) formed by stacking the first electrode and the first ionomer material (71) whose ion exchange capacity per unit area under a predetermined temperature and predetermined humidity atmosphere is less than a predetermined value; the second stacked body providing step (S1b) of providing the second stacked body (72) formed by stacking the second electrode and the second ionomer material (73) whose ion exchange capacity per unit area under the predetermined temperature and predetermined humidity atmosphere is equal to or greater than the predetermined value; the substrate providing step (S1c) of providing the electrolyte substrate (74) including the first surface (741) and the second surface (742) on an opposite side from the first surface; the swelling step (S2) of swelling the first stacked body, the second stacked body, and the electrolyte substrate; and the joining step (S3) of, after the swelling step, joining together the first surface of the electrolyte substrate and the first ionomer material of the first stacked body, and joining together the second surface of the electrolyte substrate and the second ionomer material of the second stacked body.

### Supplementary Note 2

In the method for manufacturing the membrane electrode assembly according to Supplementary Note 1, the thickness (t1) of the first ionomer material in the stacking direction of the first electrode and the first ionomer material may be different from the thickness (t2) of the second ionomer material in the stacking direction of the second electrode and the second ionomer material.

### Supplementary Note 3

In the method for manufacturing the membrane electrode assembly according to Supplementary Note 1 or 2, each of the first stacked body, the second stacked body, and the electrolyte substrate may have a circular shape, the diameter of each of the first stacked body and the second stacked body may be smaller than the diameter of the electrolyte substrate, and in the joining step, on the inner side of the holding member configured to hold the outer peripheral edge portion of the electrolyte substrate, the first stacked body and the electrolyte substrate may be joined together, and the second stacked body and the electrolyte substrate may be joined together.

Although the present disclosure has been described in detail, the present disclosure is not limited to the above-described individual embodiments. Various additions, replacements, modifications, partial deletions, and the like can be made to these embodiments without departing from the gist of the present disclosure, or without departing from the essence of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A method for manufacturing a membrane electrode assembly used in a differential pressure electrolysis apparatus including the membrane electrode assembly that includes an electrolyte membrane, and a first electrode and a second electrode that are stacked on both sides of the electrolyte membrane, respectively, the differential pressure electrolysis apparatus being configured to supply a fluid for electrolysis to the first electrode, apply a voltage between the first electrode and the second electrode, and obtain, at the second electrode, a second gas at a higher pressure than a first gas obtained at the first electrode, the method comprising:
providing a first stacked body formed by stacking the first electrode and a first ionomer material whose ion exchange capacity per unit area under a predetermined temperature and predetermined humidity atmosphere is less than a predetermined value;
providing a second stacked body formed by stacking the second electrode and a second ionomer material whose ion exchange capacity per unit area under the predetermined temperature and predetermined humidity atmosphere is equal to or greater than the predetermined value;
providing an electrolyte substrate including a first surface and a second surface on an opposite side from the first surface;
swelling the first stacked body, the second stacked body, and the electrolyte substrate; and
after the swelling of the first stacked body, the second stacked body, and the electrolyte substrate, joining together the first surface of the electrolyte substrate and the first ionomer material of the first stacked body, and joining together the second surface of the electrolyte substrate and the second ionomer material of the second stacked body.

2. The method for manufacturing the membrane electrode assembly according to claim 1, wherein
a thickness of the first ionomer material in a stacking direction of the first electrode and the first ionomer material is different from a thickness of the second ionomer material in a stacking direction of the second electrode and the second ionomer material.

3. The method for manufacturing the membrane electrode assembly according to claim 1, wherein
each of the first stacked body, the second stacked body, and the electrolyte substrate has a circular shape,
a diameter of each of the first stacked body and the second stacked body is smaller than a diameter of the electrolyte substrate, and
in the joining, on an inner side of a holding member configured to hold an outer peripheral edge portion of the electrolyte substrate, the first stacked body and the electrolyte substrate are joined together, and the second stacked body and the electrolyte substrate are joined together.
